(19) United States
(12) Patent Application Publication
(10) Pub. No.: US 2008/0297108 A1
(43) Pub. Date: Dec. 4, 2008

(54) Automatic Cycle Storage System and Cycle for this System

(75) Inventor: Jacques Le Gars, Gambais (FR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: JCDecaux SA, Neuilly sur SEINE (FR)

(21) Appl. No.: 10/573,237

(22) PCT Filed: Mar. 8, 2006
(86) PCT No.: PCT/FR2006/000518

§ 371 Date: Aug. 21, 2008

(30) Foreign Application Priority Data
Mar. 11, 2005 (FR) 05/02423

(51) Int. Cl. H02J 7/00

(52) U.S. Cl. 320/109

(57) ABSTRACT

Automatic system for storing electric cycles, in which the batteries of the cycles (1) are recharged by locking stations (1). The electronic control circuit of each cycle prevents the operation of a battery recharging circuit while the cycle is not locked onto the locking station.

The present invention relates to automatic cycle storage systems and to cycles for these systems, intended in particular to be made temporarily available to the public.

More specifically, the invention relates to an automatic cycle storage system comprising:
a plurality of cycles (for example, bicycles), each carrying a locking device and an electronic control circuit,
a plurality of locking stations onto which the locking devices of the cycles can be locked when they are not in use,
and at least one control device adapted to selectively enable the borrowing of cycles from at least some locking stations, the control device being adapted to interact with the electronic control circuit of a cycle locked onto a locking station corresponding to said control device.

Document WO-A-02/095698 describes an example of such a cycle storage system.

The object of the present invention is, in particular, to make further improvements to systems of this type.

For this purpose, according to the invention, a cycle storage system of the kind in question is characterized in that at least some of the locking stations comprise an electrical power source and a first electrical power supply interface adapted to transfer electrical power from the electrical power source to a cycle locked onto said locking station, in that at least some of the cycles are electrically propelled cycles, comprising an electric propulsion motor supplied by a main battery, the main battery being connected to a recharging circuit controlled by the electronic control circuit, said recharging circuit being connected to a second electrical power supply interface which is adapted to receive electrical power from the electrical power source via the first electrical power supply interface when the cycle is locked onto the locking station, and in that the electronic control circuit is adapted to determine whether the cycle is locked onto the locking station and to enable the recharging circuit to operate to charge the main battery only if the cycle is locked onto the locking station.

Because of these arrangements, the users of the system are able to borrow electrically propelled cycles, while the batteries of these cycles can be recharged in good conditions and a high degree of theft prevention is provided. This is because a stolen cycle cannot easily be recharged away from the automatic cycle storage system, and will therefore become virtually unusable because of its relatively high weight (an electrically propelled cycle is always markedly heavier than a purely human-propelled cycle).

In different embodiments of the invention, any one and/or other of the following arrangements can also be used if required:
the electronic control circuit is adapted to enable the recharging circuit to operate to charge the main battery only after a predetermined dialogue with the control device when the cycle is locked onto the locking station;
the locking device of the cycle interacts with a complementary locking device belonging to the locking station, the first and second electrical power supply interfaces being fixed respectively to the complementary locking device and the locking device;
the locking device and the complementary locking device are adapted to interact by fitting into each other, thus masking the first and second electrical power supply interfaces when the cycle is locked onto the locking station;
the control device is adapted to control the electrical power source and to supply said first electrical power supply interface with electrical power only if the cycle is locked onto the locking station;
the locking station comprises an anchoring member, and the locking device of each cycle has an electric bolt controlled by the electronic control circuit of the cycle and adapted to be locked onto the anchoring member;
the anchoring member comprises identification means readable by the electronic control circuit of the cycle;
the control device has a first short-range wireless communication interface, the cycle has a second short-range wireless communication interface adapted to communicate with the first communication interface, this second communication interface being connected to the electronic control circuit of the cycle, and the control device is adapted to control the locking device of each cycle via the first communication interface and the second communication interface;
the first and second communication interfaces are radio communication interfaces;
the electrical power source delivers a low voltage (for example, less than 20 volts);
the recharging circuit is adapted to supply a secondary battery as long as an electrical voltage is present at the second power supply interface, said secondary battery supplying the electronic control circuit;
the control device is adapted to communicate with the electronic control circuit of the cycle by carrier current modulation, via the first and second electrical power supply interfaces.

The invention also relates to a cycle for a system as defined above, this cycle having:
a locking device,
an electronic control circuit,
an electric propulsion motor adapted to propel the cycle,
a main battery supplying the electric motor,
a recharging circuit controlled by the electronic control circuit and connected to the main battery,
an electrical power supply interface connected to said recharging circuit and adapted to receive electrical power from an external electrical power source when the cycle is locked onto a locking station, the electronic control circuit being adapted to determine whether the cycle is locked onto the locking station and to enable the recharging circuit to operate to charge the main battery only if the cycle is locked onto said locking station.

Other characteristics and advantages of the invention will be made clear by the following description of two embodiments thereof, provided by way of example and without restrictive intent, with reference to the attached drawings.

In the drawings:

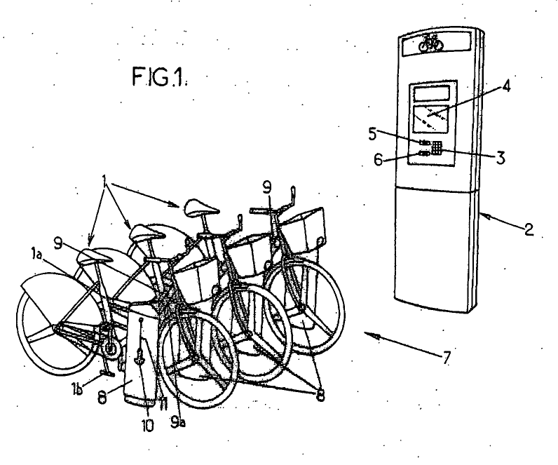

FIG. 1 is a schematic perspective view showing an automatic cycle storage system according to a first embodiment of the invention,

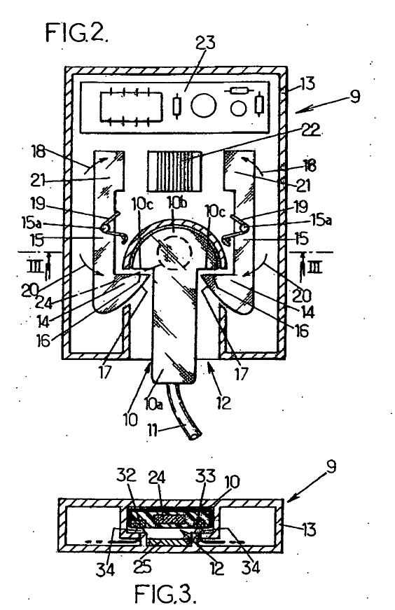

FIG. 2 is a sectional detail view of the cycle locking device of FIG. 1, locked onto an anchoring member of one of the locking stations,

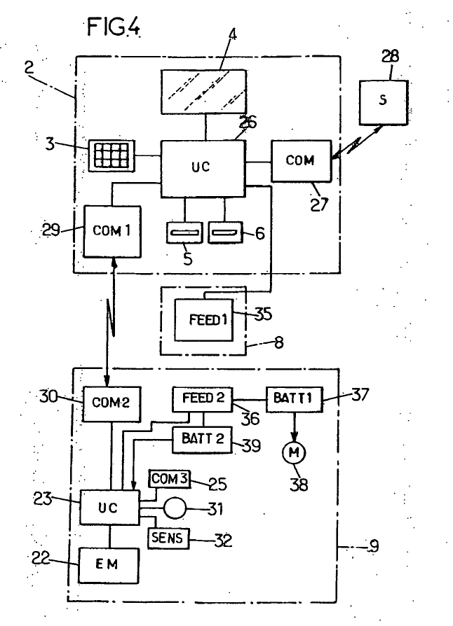

FIG. 3 is a sectional view taken along the line III-III of FIG. 2, and

FIG. 4 is a block diagram of the cycle storage system of FIG. 1.

In the different figures, the same references denote identical or similar elements.

As shown in FIG. 1, the present invention relates to an automatic system 1 for storing cycles such as, in particular, bicycles, which enables these cycles to be stored, for example, on the public highway in such a way that they are made available to the public. At least some of the cycles 1 are electrically propelled cycles of a known type.

This automatic cycle storage system has, for example in each cycle storage area 7, a control device such as an interactive terminal 2 provided with a user interface comprising, for example, a keypad 3, a screen 4, a portable electronic card reader 5 and, if necessary, a ticket issue device 6 used, for example, to confirm a payment, or an authorization for collection from a debit card account, or for other purposes.

The cycle storage area 7, comprising for example a plurality of locking stations 8, is located in the vicinity of the interactive terminal 2 to receive the cycles 1 when they are not in use.

When it is returned to the storage area 7, each cycle 1 can rest, for example, on a stand lb mounted pivotably on its frame la. Additionally, as shown in FIG. 2, each cycle has a locking device 9, which can, for example, be mounted on a collar 9a or other support fixed rigidly to the frame la of each cycle, and which enables the cycle 1 to be locked onto a locking station 8.

Each locking device 9 is adapted to be locked onto a complementary locking device belonging to the locking station 8, for example a passive anchoring member 10 (in other words, one which is not electrically activated) fixed to the corresponding locking station 8.

In the example shown in FIG. 1, each locking station 8 can, for example, take the form of a vertical terminal fixed to the ground and, as shown in greater detail in FIG. 2, each anchoring member 10 can take the form of a flat key, made from plastics material for example, connected for example to the corresponding locking station 8 by a cable 11, for example a sheathed electrical cable (advantageously having a vandal-resistant sheath).

As shown in FIG. 2, the anchoring member 10 can, for example, take the form of a plate having an elongate body 10a and an enlarged head 10b having, for example, two shoulders 10c facing towards the elongate body 10a. The anchoring member 10 can be connected to the cable 11, for example, via the end of the elongate body 10a located opposite the enlarged head 10b.

As shown in FIGS. 2 and 3, the anchoring member 10 can, for example, engage, with a small amount of play, in a slot 12 in the casing 13 of the locking device 9.

Two hooks 14, each carried by a lever 15 pivoting in the casing 13 about an axis 15a located in an intermediate position along the lever 15, can also be positioned within this casing 13. Each hook 14 is adapted to penetrate laterally into the slot 12.

Each of the hooks 14 can have:
a stop edge 16 adapted to engage behind one of the shoulders 10c of the anchoring member 10 when said anchoring member is fully engaged in the slot 12,
and a cam edge 17 which is orientated towards the opening of the slot 12 and which extends diagonally, in such a way that, when the anchoring member 10 is introduced into the slot 12, the enlarged head 10b of the anchoring member can push the hooks 14 back outwards in the direction of the arrows 18, until they reach a retracted position allowing the passage of said enlarged head 10b.

If necessary, the enlarged head 10b can have in its front part, in other words at the end opposite the elongate body 10a, a rounded or chamfered edge, enabling the hooks 14 to be pushed back more easily in the direction 18 when the anchoring member 10 is inserted into the slot 12.

Each of the levers 15 is acted on resiliently by a spring 19, in the direction of the arrows 20, towards the locking position shown in FIG. 2, where the corresponding hook 14 projects into the slot 12. Additionally, on the opposite side from the hooks 14 in relation to the corresponding pivoting axes 15a, the ends 21 of the levers 15 are positioned on either side of an electromagnet 22 which is connected to an electronic control circuit 23. When the electronic control circuit 23 supplies the electromagnet 22, the latter attracts the two ends 21 of the levers 15 towards it, thus moving them in the direction of the arrows 18 towards their retracted position, which then enables the anchoring member 10 to be released. The hooks 14, the levers 15 and the electromagnet 22 thus form an electric lock.

As shown in FIG. 3, the locking device 9 can also have a communication interface 25 adapted to read (by induction, for example) a miniature electronic circuit 24 which is integrated in the anchoring member, for example by being embedded in the material from which this anchoring member is made. This electronic circuit 24 can contain, for example, an identification code of the corresponding locking station 8.

The anchoring member 10 can also have a first electrical power supply interface, in this case formed by connecting terminals 33 which are adapted to come into contact with complementary connecting terminals 34 belonging to the locking device 9. When the anchoring member 10 is fitted into the locking device 9, the connecting terminals 33, 34 are masked, which contributes to the elimination of electrical hazards for the public.

As shown in FIG. 4, the interactive terminal 2 can have an electronic central unit 26 (UC) such as a microprocessor or the like, which communicates with the keypad 3, the screen 4, the card reader 5 and the ticket issue device 6. The central unit 26 also communicates with a communication interface 27 (COM), which itself can communicate with a central server 28 (S), for example by radio or by other means.

The central unit 26 of the interactive terminal 2 is also connected to a short-range wireless communication interface 29 (COM1) having a range limited substantially to the storage area 7, and being for example generally less than 50 m, and advantageously of the order of 10 m.

This communication interface 29 is adapted to communicate remotely with a similar communication interface 30 (COM2) belonging to the locking device 9 of each cycle. The two communication interfaces 29, 30 can advantageously be interfaces communicating by radio, advantageously according to a short-range radio communication protocol selected from the Bluetooth, WiFi, DECT and Zigbee protocols.

If necessary, the shape of the spatial coverage of the interface 12 can be adapted to the configuration of the locality, by the selection and/or orientation of the antenna of said interface 12.

Each locking station also comprises an electrical power source 35 (FEED 1) consisting, for example, of an electrical power supply circuit controlled by the central unit 26 of the interactive terminal 2 and supplied, for example, from the public electricity supply. The electrical power source 35 is adapted to supply selectively the first electrical power supply interface, in other words the connecting terminals 33, preferably at low voltage (for example at a voltage of less than 20 volts).

The electronic control circuit 23 (UC) of each cycle 1, which can in particular comprise a microprocessor, is connected to the communication interface 30, to the electromagnet 22 (EM), to the interface 25 (COM 3) and if necessary to a signaling device 31 such as a light-emitting diode and to a sensor 32 (SENS) adapted to detect the position of the stand 1b.

The electronic control circuit 23 of the cycle also controls an electrical recharging circuit 36 (FEED 2) which is connected:
to the second electrical power supply interface (in this case, the connecting terminals 34),
to a main battery 37 (BATT1) supplying the electric motor 38 (M) of the cycle.

The recharging circuit 36 is also connected to a secondary battery 39 (BATT2) which supplies the electronic control circuit 23. This secondary battery can be constantly recharged by the dynamo of the cycle if required.

The device described above operates as follows.

When a user wishes to borrow a cycle 1 present in the storage area 7, he can, for example, insert an electronic debit card into the reader 5 of the interactive terminal 2, and then enter a secret code by means of the keypad 3.

The terminal 2 then communicates with the server 28 to obtain authorization to release a cycle 1 present in the storage area 7. All the cycles 1 present in the storage area 7 can be identified by the interactive terminal 2, since these cycles 1 communicate with said interactive terminal by means of the communication interfaces 29, 30.

Authorization to release a cycle is given, for example, according to the validity of a subscription of the user, or if necessary according to a communication of the interactive terminal 2 and/or the server 28 with a cash server (not shown).

When the interactive terminal 2 receives the authorization to release a cycle 1, it sends an order by radio towards one of the cycles 1 in the storage area 7, in such a way that the electronic control circuit 23 of this cycle operates the electromagnet 22 to release the anchoring member inserted into the corresponding locking device 9. At the same time, the interactive terminal 2 can also send an identification code of the user or a transaction identification code towards the cycle 1 in question, and the electronic control circuit 23 of this cycle stores this code.

The electronic control circuit 23 of the cycle can then cause its light-emitting diode 31 to flash so that the user can identify the unlocked cycle. The user can then freely borrow this cycle and use it.

Subsequently, when the user wishes to return the borrowed cycle to a storage area 7 (which can be the storage area from which the cycle was borrowed, or another similar storage area), he simply has to bring the cycle back to the desired storage area 7, lower the stand 1b of the cycle, and insert the anchoring member 10 of one of the locking stations 8 into the slot 12 of its locking device, so that this anchoring member is automatically locked by the hooks 14.

The interactive terminal 2 corresponding to this storage area 7, which has established communication with the cycle 1 by radio as soon as this cycle entered the storage area 7, then sends an end of transaction data element to the server, after having checked:
the user or transaction identifier stored in the electronic control circuit 23 of the cycle,
the locking station 8 onto which the cycle is locked, by reading the electronic circuit 24 of the anchoring member,
and, if necessary, the position of the stand 1b.

Before the cycle is locked onto the locking station 8, the central unit 26 of the interactive terminal 2 disables the power supply circuit 35, so that no voltage is applied to the connecting terminals 33 of the anchoring member, and, similarly, the electronic control circuit 23 of the locking device blocks the operation of the recharging circuit 36 for recharging the main battery 37, so that it is not possible to recharge the main battery 37 by connecting any electrical power source to the connecting terminals 34 of the locking device.

When the cycle is locked onto the locking station 8, the electronic control circuit 23 identifies this locking by means of the interface 25 which detects the electronic circuit 24 of the anchoring member. The correct locking of the cycle can also be determined by the electronic control circuit 23 not only after this detection of the circuit 24, but also after a predetermined dialogue with the interactive terminal 2, a dialogue which can be terminated for example by an acknowledgement of receipt from the interactive terminal 2 or by an order for recharging the battery sent by said interactive terminal 2.

The electronic control circuit 23 then operates the electrical recharging circuit 36 so as to enable the recharging of the main battery 37. The electronic control circuit 23 also communicates with the central unit 26 of the interactive terminal, which in turn controls the power supply circuit 35 so that it supplies the connecting terminals 33 with electrical power. The main battery 37 of the cycle is then recharged from the power supply circuit 35 of the locking station.

It should be noted that, if necessary, the power supply circuit 35 can supply the connecting terminals 33 of the anchoring member 10 constantly, particularly if this anchoring member is protected from bad weather by any known method, for example if the locking stations 8 are positioned in a sheltered place or if the anchoring member were positioned in a housing (not shown) of the locking station into which the locking device of the cycle would penetrate.

In this case, since the electrical recharging circuit 36 always allows the secondary battery 39 to be recharged, the constant supply of power to the electronic control circuit 33 is guaranteed when the cycle is locked onto its locking station, thus enabling said electronic control circuit to operate normally even if the cycle 1 is returned to the locking station 8 with its main battery 37 and its secondary battery 39 completely discharged.

Additionally, when the power supply circuit 35 constantly applies a voltage to the connecting terminals 33, it will be noted that it would be possible to make the electronic control circuit 23 communicate with the central unit 26 by carrier current modulation, via the power supply circuit 35 and the electrical recharging circuit 36.

1. An automatic cycle storage system comprising:
a plurality of cycles, each carrying a locking device and an electronic control circuit,
a plurality of locking stations onto which the locking devices of the cycles can be locked when they are not in use,
and at least one control device adapted to selectively enable the borrowing of cycles from at least some locking stations, the control device being adapted to interact with the electronic control circuit of a cycle locked onto a locking station corresponding to said control device,
wherein at least some of the locking stations comprise an electrical power source and a first electrical power supply interface adapted to transfer electrical power from the electrical power source to a cycle locked onto said locking station,
wherein at least some of the cycles are electrically propelled cycles, each comprising an electric propulsion motor supplied by a main battery, the main battery being connected to a recharging circuit controlled by the electronic control circuit, said recharging circuit being connected to a second electrical power supply interface which is adapted to receive electrical power from the electrical power source via the first electrical power supply interface when the cycle is locked onto the locking station, and wherein the electronic control circuit is adapted to determine whether the cycle is locked onto the locking station and to enable the recharging circuit to operate to charge the main battery only if the cycle is locked onto the locking station.

2. The system as claimed in claim 1, in which the electronic control circuit is adapted to enable the recharging circuit to operate to charge the main battery only after a predetermined dialogue with the control device when the cycle is locked onto the locking station.

3. The system as claimed in claim 1, in which the locking device of the cycle interacts with a complementary locking device belonging to the locking station, the first and second electrical power supply interfaces being fixed respectively to the complementary locking device and the locking device.

4. The system as claimed in claim 3, in which the locking device and the complementary locking device are adapted to interact by fitting into each other, thus masking the first and second electrical power supply interfaces when the cycle is locked onto the locking station.

5. The system as claimed in claim 1, in which the control device is adapted to control the electrical power source and to supply said first electrical power supply interface with electrical power only if the cycle is locked onto the locking station.

6. The system as claimed in claim 1, in which the locking station comprises an anchoring member, and the locking device of each cycle has an electric bolt controlled by the electronic control circuit of the cycle and adapted to be locked onto the anchoring member.

7. The system as claimed in claim 6, in which the anchoring member comprises identification means readable by the electronic control circuit of the cycle.

8. The system as claimed in claim 1, in which the control device has a first short-range wireless communication interface, the cycle has a second short-range wireless communication interface adapted to communicate with the first communication interface, this second communication interface being connected to the electronic control circuit of the cycle, and the control device is adapted to control the locking device of each cycle via the first communication interface and the second communication interface.

9. The system as claimed in claim 8, in which the first and second communication interfaces are radio communication interfaces.

10. The system as claimed in claim 1, in which the electrical power source delivers a low voltage.

11. System as claimed in claim 1, in which the recharging circuit is adapted to supply a secondary battery as long as an electrical voltage is present at the second power supply interface, said secondary battery supplying the electronic control circuit.

12. The system as claimed in claim 1, in which the control device is adapted to communicate with the electronic control circuit of the cycle by carrier current modulation, via the first and second electrical power supply interfaces.

13. A cycle for a system as claimed in claim 1, this cycle having:
a locking device,
an electronic control circuit,
an electric propulsion motor adapted to propel the cycle,
a main battery supplying the electric motor,
a recharging circuit controlled by the electronic control circuit and connected to the main battery,
an electrical power supply interface connected to said recharging circuit and adapted to receive electrical power from an external electrical power source when the cycle is locked onto a locking station,
the electronic control circuit being adapted to determine whether the cycle is locked onto the locking station and to enable the recharging circuit to operate to charge the main battery only if the cycle is locked onto said locking station.
